(19) United States
(12) Patent Application Publication
(10) Pub. No.: US 2023/0272755 A1
(43) Pub. Date: Aug. 31, 2023

(54) CONTROLLER AND CONTROL METHOD FOR INTERNAL COMBUSTION ENGINE

(71) Applicant: TOYOTA JIDOSHA KABUSHIKI KAISHA, Toyota-shi (JP)

(72) Inventor: Yusuke AOYAGI, Toyota-shi (JP)

(73) Assignee: TOYOTA JIDOSHA KABUSHIKI KAISHA, Toyota-shi (JP)

(21) Appl. No.: 18/157,925

(22) Filed: Jan. 23, 2023

(30) Foreign Application Priority Data
Feb. 25, 2022 (JP) 2022-027756

(51) Int. Cl. F02D 41/00; F02D 41/14

(52) U.S. Cl. CPC F02D 41/0077; F02D 41/1446; F02D 2041/1472; F02D 2200/022

(57) ABSTRACT

A controller is configured to control an internal combustion engine that includes an exhaust gas temperature sensor. The exhaust gas temperature sensor detects, as an exhaust gas temperature, a temperature of exhaust gas flowing through an exhaust passage. The controller is configured to execute an estimation process that estimates a generation amount per unit time of condensed water generated in the exhaust passage. In the estimation process, the controller estimates a lower value of the generation amount for a higher value of the exhaust gas temperature that is detected by the exhaust gas temperature sensor.

### BACKGROUND

### 1. Field

The present disclosure relates to a controller and a control method for an internal combustion engine.

### 2. Description of Related Art

Japanese Laid-Open Patent Publication No. 2016-125458 discloses an internal combustion engine that includes multiple cylinders, an intake passage, and an exhaust passage. Each cylinder is a space in which air-fuel mixture of intake air and fuel is burned. The intake passage supplies intake air into the cylinders. The exhaust passage discharges exhaust gas from the inside of the cylinders. The internal combustion engine also includes a water jacket and a coolant temperature sensor. The water jacket is a passage for coolant and is defined inside the internal combustion engine. The coolant temperature sensor detects a temperature of coolant at the outlet of the water jacket as a coolant temperature.

The controller for an internal combustion engine disclosed in the above-described publication estimates the amount of condensed water generated in the exhaust passage. The controller estimates the amount of condensed water based on the coolant temperature of the internal combustion engine.

In the internal combustion engine described in the above-described publication, the amount of condensed water generated in the exhaust passage varies depending on the temperature of the inner wall surface of the exhaust passage. However, a change in the temperature of the inner wall surface of the exhaust passage does not necessarily correspond to a change in the coolant temperature of the internal combustion engine in some cases. Therefore, the amount of condensed water may not be accurately estimated in the process executed by the controller for an internal combustion engine.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a controller for an internal combustion engine is provided. The internal combustion engine includes an exhaust gas temperature sensor that detects, as an exhaust gas temperature, a temperature of exhaust gas flowing through an exhaust passage. The controller is configured to execute an estimation process that estimates a generation amount per unit time of condensed water generated in the exhaust passage. In the estimation process, the controller estimates a lower value of the generation amount for a higher value of the exhaust gas temperature that is detected by the exhaust gas temperature sensor.

In the above-described configuration, the generation amount of the condensed water depends on the temperature of the inner wall surface of the exhaust passage. The temperature of the inner wall surface of the exhaust passage depends on the exhaust gas temperature. In the above-described configuration, the controller estimates a lower value of the generation amount of condensed water for a higher value of the exhaust gas temperature. That is, the controller accurately estimates the generation amount of condensed water per unit time based on the exhaust gas temperature, which has a strong correlation with the generation amount of condensed water.

In the above-described configuration, the internal combustion engine may include a coolant temperature sensor that detects, as a coolant temperature, a temperature of a coolant flowing inside the internal combustion engine. In the estimation process, the controller may estimate a higher value of the generation amount for a higher value of a degree of deviation between the exhaust gas temperature that is detected by the exhaust gas temperature sensor and the coolant temperature that is detected by the coolant temperature sensor.

In the above-described configuration, the inner wall surface of the exhaust passage exchanges heat with the coolant flowing through the internal combustion engine. The inner wall surface of the exhaust passage is thus affected not only by the exhaust gas temperature but also by the coolant temperature. With the above-described configuration, the controller estimates a higher value of the generation amount of condensed water for a higher value of the difference between the exhaust gas temperature and the coolant temperature. The controller thus estimates the generation amount of condensed water based on not only the exhaust gas temperature, but also the difference between the exhaust gas temperature and the coolant temperature. The difference is a value accurately representing the temperature of the inner wall surface of the exhaust passage. The controller thus accurately estimates the generation amount of condensed water per unit time.

In the above-described configuration, the controller may estimate, in the estimation process, a higher value of the generation amount for a higher value of an intake air amount of the internal combustion engine.

The larger the intake air amount is, the more water that becomes condensed water enters the exhaust passage. With the above-described configuration, the controller estimates a higher value of the amount of condensed water for a higher value of the intake air amount. Therefore, the controller estimates the generation amount of condensed water while taking the intake air amount into consideration.

In the above-described configuration, the internal combustion engine includes an EGR passage configured to recirculate exhaust gas flowing through the exhaust passage to an intake passage, and an EGR valve configured to regulate a flow rate of exhaust gas recirculated from the exhaust passage to the intake passage. The controller is configured to execute an accumulation process and a recirculation prohibiting process. The accumulation process accumulates the generation amount that is estimated by the estimation process so as to calculate an accumulation value of the condensed water that has been generated since the internal combustion engine was started. The recirculation prohibiting process fully closes the EGR valve when the accumulation value that is calculated by the accumulation process, is higher than a predetermined accumulation threshold.

With the above-described configuration, when the estimated amount of condensed water is greater than or equal to the threshold, the controller controls the EGR valve such that the EGR valve does not open. This prevents condensed water from entering the intake passage through the EGR passage via the EGR valve.

In the above-described configuration, the recirculation prohibiting process may be prohibited when the exhaust gas temperature that is detected by the exhaust gas temperature sensor is higher than a predetermined exhaust gas temperature threshold.

When the exhaust gas temperature is relatively high, the temperature of the wall surface of the exhaust passage becomes correspondingly high, so that no condensed water is generated on the wall surface of the exhaust passage. With the above-described configuration, when the exhaust gas temperature is higher than the exhaust gas temperature threshold, the recirculation prohibiting process is prohibited. That is, the recirculation prohibiting process is not executed. Therefore, when it is expected that condensed water will be no longer generated, part of the exhaust gas is recirculated to the intake passage with condensed water being prevented from entering the intake passage.

In another general aspect, a method for controlling an internal combustion engine is provided. The internal combustion engine including an exhaust gas temperature sensor that detects, as an exhaust gas temperature, a temperature of exhaust gas flowing through an exhaust passage. The method includes executing an estimation process that estimates a generation amount per unit time of condensed water generated in the exhaust passage. The estimation process includes estimating a lower value of the generation amount for a higher value of the exhaust gas temperature that is detected by the exhaust gas temperature sensor.

Other features and aspects will be apparent from the following detailed description, the drawings, and the claims.

### BRIEF DESCRIPTION OF THE DRAWINGS

FIG. 1 is a schematic diagram of an internal combustion engine.

FIG. 2 is a flowchart showing a series of processes including an estimation process.

FIG. 3 is a timing diagram, where part (a) shows changes in temperature after a start of the internal combustion engine, and part (b) shows changes in an intake air amount after the start of the internal combustion engine.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Embodiment

Hereinafter, a controller 100 and control method for an internal combustion engine 10 according to one embodiment will be described with reference to the drawings. In the present embodiment, the internal combustion engine 10 is mounted on a vehicle VC.

### Overall Configuration of Internal Combustion Engine

First, an overall configuration of the internal combustion engine 10 with which the controller 100 is used will be described.

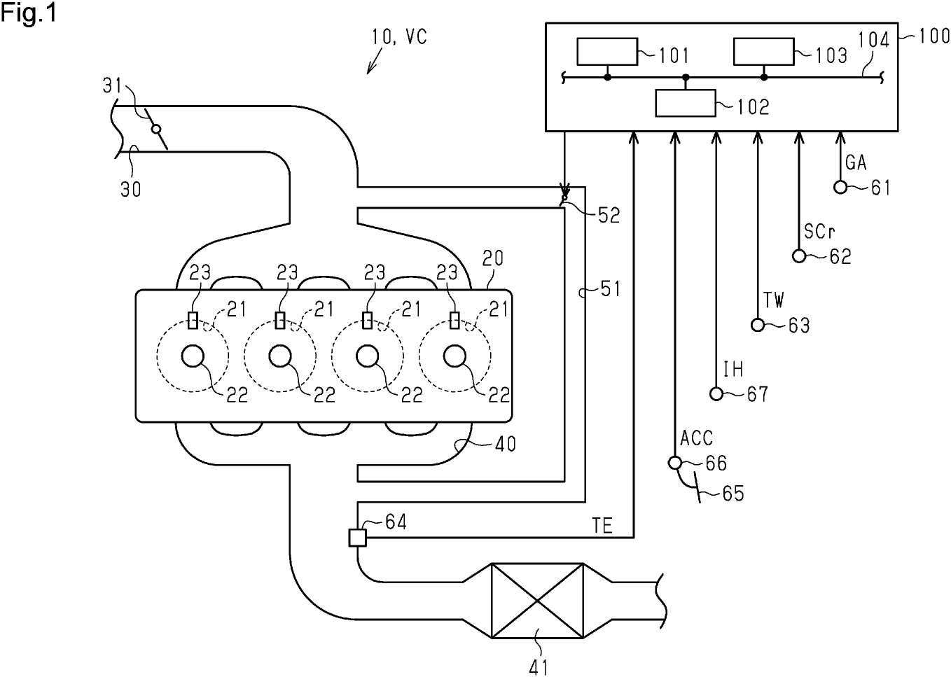

As shown in FIG. 1, the internal combustion engine 10 includes an engine main body 20, an intake passage 30, and an exhaust passage 40.

The engine main body 20 includes multiple cylinders 21. Each cylinder 21 is a space defined in the engine main body 20. A piston (not shown) is located in each cylinder 21. The piston is coupled to a crankshaft via a connecting rod (not shown). The piston reciprocates within the cylinder 21. The cylinder 21 includes a combustion chamber, which is a space between an inner surface of the cylinder 21 and a top surface of the piston. The combustion chamber of each cylinder 21 is a space in which air-fuel mixture of intake air and fuel is burned.

The engine main body 20 includes multiple ignition plugs 22. The ignition plugs 22 are provided for the respective cylinders 21. The distal end of each ignition plug 22 is located in the combustion chamber of the corresponding cylinder 21. The ignition plug 22 ignites air-fuel mixture in the combustion chamber of the cylinder 21.

The engine main body 20 includes multiple fuel injection valves 23. The fuel injection valves 23 are provided for the respective cylinders 21. Each fuel injection valve 23 injects fuel into the combustion chamber of the corresponding cylinder 21.

The intake passage 30 is a passage for supplying intake air to each cylinder 21. The intake passage 30 includes multiple downstream ends, which are respectively connected to the cylinders 21. The intake passage 30 incorporates a throttle valve 31. The throttle valve 31 regulates an intake air amount GA, which is a flow rate of air flowing through the intake passage 30 per unit time, by changing a valve opening degree. The air taken in through the intake passage 30 flows into the cylinders 21.

The exhaust passage 40 is a passage for discharging exhaust gas generated by combustion in each cylinder 21. The exhaust passage 40 includes multiple upstream ends, which are respectively connected to the combustion chambers of the cylinders 21. The exhaust passage 40 accommodates an exhaust purification catalyst 41. The exhaust purification catalyst 41 removes, for example, carbon monoxide and nitrogen oxide contained in the exhaust gas.

The internal combustion engine 10 includes an EGR passage 51 and an EGR valve 52. The EGR passage 51 is a passage for recirculating exhaust gas flowing through the exhaust passage 40 to the intake passage 30 as EGR gas. The upstream end of the EGR valve 52 is connected to a section of the exhaust passage 40 that is on the upstream side of the exhaust purification catalyst 41. The downstream end of the EGR valve 52 is connected to a section of the intake passage 30 that is on the downstream side of the throttle valve 31. The EGR valve 52 is located halfway in the EGR passage 51. The EGR valve 52 regulates the flow rate of EGR gas flowing through the EGR passage 51. That is, the EGR valve 52 regulates the flow rate of exhaust gas recirculated from the exhaust passage 40 to the intake passage 30.

The internal combustion engine 10 is provided with an air flow meter 61. The air flow meter 61 is located in a section of the intake passage 30 that is on the upstream side of the throttle valve 31. The air flow meter 61 detects the intake air amount GA.

The internal combustion engine 10 is provided with a crank angle sensor 62. The crank angle sensor 62 detects a rotational position SCr of the crankshaft of the engine main body 20.

The internal combustion engine 10 is provided with a coolant temperature sensor 63. The coolant temperature sensor 63 detects the temperature of coolant flowing through the water jacket of the engine main body 20 as a coolant temperature TW.

The internal combustion engine 10 is provided with an exhaust gas temperature sensor 64. The exhaust gas temperature sensor 64 detects the temperature of exhaust gas flowing through the exhaust passage 40 as an exhaust gas temperature TE. The exhaust gas temperature sensor 64 is in the section of the exhaust passage 40 that is on the upstream side of the exhaust purification catalyst 41.

The vehicle VC, on which the internal combustion engine 10 is mounted, includes an accelerator pedal 65 and an accelerator position sensor 66. The accelerator pedal 65 is operated by the driver of the vehicle VC, on which the internal combustion engine 10 is mounted. The accelerator position sensor 66 detects an accelerator operated amount ACC, which is the operated amount of the accelerator pedal 65.

The internal combustion engine 10 is equipped with a humidity sensor 67. The humidity sensor 67 detects the humidity of the intake air flowing through the intake passage 30 as an intake air humidity IH. The humidity sensor 67 regards the humidity of the air outside the vehicle VC as the humidity of the intake air and detects it as the intake air humidity IH.

### Controller

The internal combustion engine 10 is provided with the controller 100. The controller 100 acquires a signal indicating the intake air amount GA from the air flow meter 61. The controller 100 acquires a signal indicating the rotational position SCr of the crankshaft from the crank angle sensor 62. The controller 100 acquires a signal indicating the coolant temperature TW from the coolant temperature sensor 63. The controller 100 acquires a signal indicating the exhaust gas temperature TE from the exhaust gas temperature sensor 64. The controller 100 acquires a signal indicating the accelerator operated amount ACC from the accelerator position sensor 66. The controller 100 acquires a signal indicating the intake air humidity IH from the humidity sensor 67.

The controller 100 includes a CPU 101 (processor), peripheral circuitry 102, a ROM 103, and a bus 104. The bus 104 communicably connects the CPU 101, the peripheral circuitry 102, and the ROM 103 to one another. The peripheral circuitry 102 includes a circuit that generates a clock signal regulating internal operations, a power supply circuit, and a reset circuit. The ROM 103 stores various programs that cause the CPU 101 to execute various control processes.

The CPU 101 constantly calculates parameters indicating the state of the engine main body 20 based on signals acquired from the various sensors. Specifically, the CPU 101 calculates an engine rotation speed based on the rotational position SCr of the crankshaft. The CPU 101 also calculates an engine load factor based on the engine rotation speed and the intake air amount GA. The engine load factor is an index value of the air filling factor in each combustion chamber of the engine main body 20. Specifically, the engine load factor is the ratio of the inflow air amount per combustion cycle of one cylinder 21 to a reference inflow air amount. The reference inflow air amount is varied in accordance with the engine rotation speed. Further, the CPU 101 calculates a fuel injection amount FA to be injected from the fuel injection valves 23 to the cylinders 21 based on the accelerator operated amount ACC.

The CPU 101 controls the internal combustion engine 10 executing various programs stored in the ROM 103. Specifically, the CPU 101 calculates a command value for regulating the flow rate of the EGR gas flowing through the EGR passage 51 based on the calculated parameters such as the engine rotation speed and the engine load factor. Then, the CPU 101 controls the opening degree of the EGR valve 52 based on the command value and parameters such as the intake air amount GA.

### Series of Processes Related to Estimation Process of Condensed Water

Next, a series of processes including an estimation process of condensed water generated in the exhaust passage 40 will be described. The CPU 101 repeatedly executes the following series of processes by executing a program stored in the ROM 103 at specified time intervals, which are determined in advance, after the internal combustion engine 10 is started. By executing the program, the controller 100 is capable of executing an estimation process, an accumulation process, a recirculation prohibiting process, and a recirculation permitting process, which will be discussed below. The CPU 101 determines that a time at which the engine rotation speed, which is calculated based on the rotational position SCr of the crankshaft, exceeds a predetermined speed is time t1, at which the internal combustion engine 10 is started. Prior to the execution of the following series of processes, an accumulation value IV of condensed water, which will be discussed below, is cleared to 0.

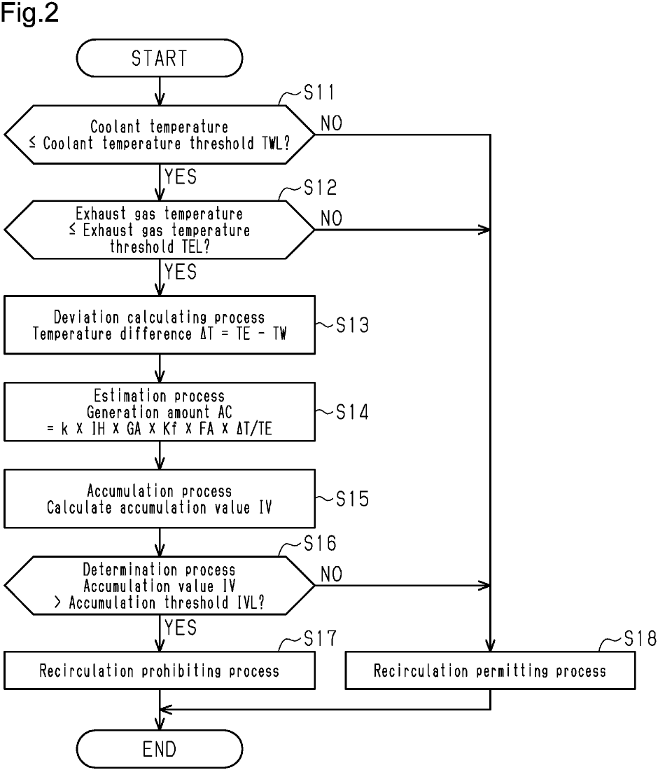

As shown in FIG. 2, the CPU 101 first executes the process of step S11. In step S11, the CPU 101 determines whether the coolant temperature TW is lower than or equal to a predetermined coolant temperature threshold TWL. The coolant temperature threshold TWL is determined in advance through tests and/or simulations as the coolant temperature TW after the engine main body 20 is sufficiently warmed up. If the coolant temperature TW is lower than or equal to the coolant temperature threshold TWL (S11: YES), the CPU 101 advances the process to step S12.

In step S12, the CPU 101 determines whether the exhaust gas temperature TE is lower than or equal to a predetermined exhaust gas temperature threshold TEL. The exhaust gas temperature threshold TEL is determined in advance through tests and/or simulations as an exhaust gas temperature TE at which condensed water is expected not to be generated. If the exhaust gas temperature TE is lower than or equal to the exhaust gas temperature threshold TEL (S12: YES), the CPU 101 advances the process to step S13.

In step S13, the CPU 101 executes a deviation calculating process. Specifically, the CPU 101 subtracts the coolant temperature TW from the exhaust gas temperature TE and uses the difference as temperature difference ΔT, which indicates the degree of deviation between the exhaust gas temperature TE and the coolant temperature TW. Thereafter, the CPU 101 advances the process to step S14.

In step S14, the CPU 101 executes an estimation process that estimates a generation amount AC per unit time of condensed water generated in the exhaust passage 40. In the estimation process, the CPU 101 first calculates the multiplication of the intake air humidity IH, the intake air amount GA per unit time, the fuel injection amount FA per unit time, and a constant coefficient Kf in order to calculate the amount of water in the exhaust gas. The coefficient Kf reflects the ratio of the amount of water generated when a certain amount of fuel is burned. Thus, the amount of water discharged from the combustion chambers of the cylinders 21 is estimated. As the estimated amount of water increases, the generation amount AC of condensed water per unit time can increase.

Next, the CPU 101 calculates a water index value by dividing the amount of water by the exhaust gas temperature TE, and multiplying the resultant by the temperature difference ΔT, which is obtained by subtracting the coolant temperature TW from the exhaust gas temperature TE. Then, the CPU 101 calculates, as the generation amount AC, a value obtained by multiplying the water index value by a specified coefficient k. The coefficient k is determined in the following manner. For example, the water index value is fixed, and the amount of condensed water that is actually generated per unit time is calculated through tests and/or simulations. The value that converts the water index value into the calculated amount of condensed water per unit time is used as the coefficient k.

In the process of step S14 described above, the CPU 101 estimates a lower value of the generation amount AC for a higher value of the exhaust gas temperature TE. The CPU 101 estimates a higher value of the generation amount AC for a higher value of the temperature difference ΔT. The CPU 101 estimates a higher value of the generation amount AC for a higher value of the fuel injection amount FA per unit time. The CPU 101 estimates a higher value of the generation amount AC for a higher value of the intake air amount GA per unit time. The CPU 101 estimates a higher value of the generation amount AC for a higher value of the intake air humidity IH. Thereafter, the CPU 101 advances the process to step S15.

In step S15, the CPU 101 executes an accumulation process. In the accumulation process, the CPU 101 adds the generation amount AC per unit time, which is estimated in the estimation process of step S13, to the accumulation value IV of condensed water that has been generated since the internal combustion engine 10 was started. Thereafter, the CPU 101 advances the process to step S16.

In step S16, the CPU 101 executes a determination process. In the determination process, the CPU 101 determines whether the accumulation value IV of condensed water from the start of the internal combustion engine 10 is larger than a predetermined accumulation threshold IVL. The accumulation threshold IVL is determined in advance, through tests and/or simulations, as a value below which the condensed water in the exhaust passage 40 does not enter excessively into the intake passage 30 even if the EGR valve 52 is opened. If the accumulation value IV is greater than the accumulation threshold IVL (S16: YES), the CPU 101 advances the process to step S17.

In step S17, the CPU 101 executes the recirculation prohibiting process. In the recirculation prohibiting process, the CPU 101 fully closes the EGR valve 52. In the recirculation prohibiting process, the CPU 101 controls the EGR valve 52 to fully close the EGR valve 52 regardless of the command value, which is calculated by the CPU 101 based on parameters such as the engine rotation speed and the engine load factor.

If the coolant temperature TW is higher than the coolant temperature threshold TWL (S11: NO), the CPU 101 advances the process to step S18. If the exhaust gas temperature TE is higher than the exhaust gas temperature threshold TEL (S12: NO), the CPU 101 advances the process to step S18. If the accumulation value IV is less than or equal to the accumulation threshold IVL (S16: NO), the CPU 101 advances the process to step S18.

In step S18, the CPU 101 executes the recirculation permitting process. In the recirculation permitting process, the state in which the recirculation is prohibited is canceled. If the recirculation prohibiting process is not being performed at the time of execution of step S18, the current state is maintained (the recirculation prohibiting process is not executed). In the recirculation permitting processing, the CPU 101 does not maintain the opening degree of the EGR valve 52 at the fully closed state. In step S18, the CPU 101 controls the opening degree of the EGR valve 52 based on parameters such as the intake air amount GA and the command value, which is calculated by the CPU 101 based on parameters such as the engine rotation speed and the engine load factor. Thereafter, the CPU 101 ends the current series of processes.

### Operation of Embodiment

In the above-described embodiment, the intake air flowing through the intake passage 30 and combustion gas after combustion of fuel contain water. The water flows through the exhaust passage 40 while hitting the inner wall surface of the exhaust passage 40. When water hits the inner wall surface of the exhaust passage 40, the water is condensed into condensed water due to the temperature difference between the water and the inner wall surface of the exhaust passage 40. In this way, condensed water is generated on the inner wall surface of the exhaust passage 40. The generation amount AC of condensed water per unit time depends on the temperature of the inner wall surface of the exhaust passage 40. The temperature of the inner wall surface of the exhaust passage 40 depends on the exhaust gas temperature TE. Specifically, when the exhaust gas temperature TE is high, the temperature of the inner wall surface of the exhaust passage 40 becomes high. When the exhaust gas temperature TE is low, the temperature of the inner wall surface of the exhaust passage 40 becomes low.

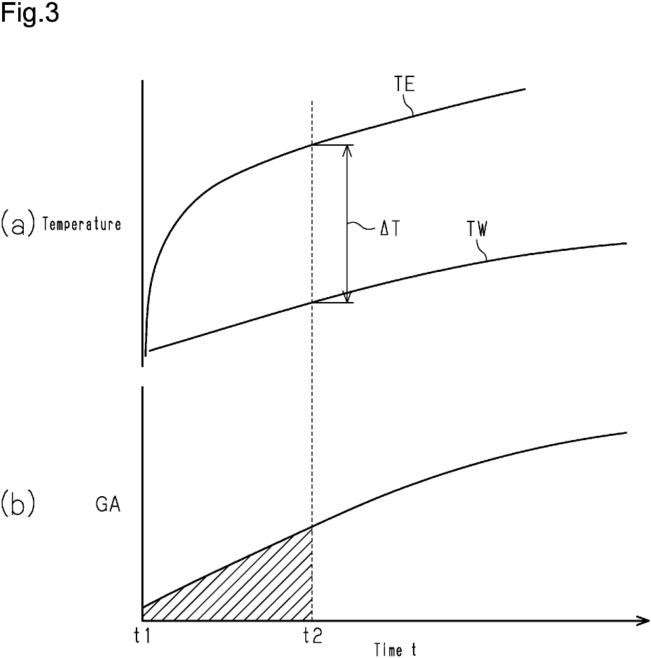

As shown in part (a) and part (b) in FIG. 3, a time t at which the internal combustion engine 10 is started is defined as time t1. In addition, time t that is a specified time after time t1 is defined as time t2. As shown in part (b) in FIG. 3, the internal combustion engine 10 is driven so that the intake air amount GA gradually increases. In this case, as shown in part (a) in FIG. 3, the exhaust gas temperature TE and the coolant temperature TW both increase from time t1 to t2. However, immediately after time t1, the exhaust gas temperature TE rapidly increases in relation to the coolant temperature TW. That is, in particular, immediately after the start of the internal combustion engine 10, the exhaust gas temperature TE is more likely to change than the coolant temperature TW. Therefore, the temperature of the inner wall surface of the exhaust passage 40 is more susceptible to changes in the exhaust gas temperature TE than the coolant temperature TW.

### Advantages of Embodiment

(1) In the above-described embodiment, the CPU 101 estimates a lower value of the generation amount AC per unit time of condensed water generated in the exhaust passage 40 for a higher value of the exhaust gas temperature TE. That is, the controller 100 accurately estimates the generation amount AC of condensed water per unit time based on the exhaust gas temperature TE, which has a strong correlation with the generation amount AC of condensed water.

(2) In the above-described embodiment, the inner wall surface of the exhaust passage 40 exchanges heat with the coolant flowing inside the engine main body 20. That is, the inner wall surface of the exhaust passage 40 is affected not only by the exhaust gas temperature TE but also by the coolant temperature TW. The larger the temperature difference ΔT between the exhaust gas temperature TE and the coolant temperature TW, the more heat is taken away from the inner wall surface of the exhaust passage 40. Accordingly, the temperature of the inner wall surface of the exhaust passage 40 decreases. As the temperature of the inner wall surface of the exhaust passage 40 decreases, the generation amount AC of condensed water per unit time increases.

In the above-described embodiment, the CPU 101 estimates a higher value of the generation amount AC of condensed water per unit time for a higher value of the temperature difference ΔT, which is the degree of deviation between the exhaust gas temperature TE and the coolant temperature TW. That is, the controller 100 estimates the generation amount AC of condensed water based on the temperature difference ΔT between the exhaust gas temperature TE and the coolant temperature TW, which is a value accurately representing the temperature of the inner wall surface of exhaust passage 40. The controller 100 thus accurately estimates the generation amount AC of condensed water per unit time.

(3) In the above-described embodiment, the larger the intake air amount GA is, the more water that can be condensed enters the exhaust passage 40. In the above-described embodiment, the controller 100 estimates a higher value of the generation amount AC per unit time of condensed water generated in the exhaust passage 40 for a higher value of the intake air amount GA. The controller 100 thus estimates the generation amount AC of condensed water while taking the intake air amount GA into consideration.

Further, the accumulation process of the above-described embodiment includes calculating the accumulation value IV by accumulating the generation amount AC. Thus, the accumulation value IV increases as the generation amount AC estimated in the estimation process increases. Therefore, the accumulation value IV increases as the total amount of the intake air amount GA after the start of the internal combustion engine 10 increases.

(4) In the above-described embodiment, the controller 100 executes the accumulation process that calculates the accumulation value IV of the condensed water generated after the start of the internal combustion engine 10. Further, when the accumulation value IV is greater than the accumulation threshold IVL, the controller 100 executes the recirculation prohibiting process. That is, when the accumulation value IV of condensed water is estimated to be excessively high, the controller 100 maintains the fully closed state of the EGR valve 52. Therefore, when an excessively large amount of condensed water is present in the exhaust passage 40, the condensed water is prevented from entering the intake passage 30 through the EGR passage 51 via the EGR valve 52 in an opened state.

(5) When the exhaust gas temperature TE is relatively high, the temperature of the inner wall surface of the exhaust passage 40 becomes relatively high, so that no condensed water is generated on the inner wall surface of the exhaust passage 40. In the above-described embodiment, when the exhaust gas temperature TE is higher than the exhaust gas temperature threshold TEL, the controller 100 does not execute the recirculation prohibiting process, that is, prohibits the recirculation prohibiting process. Therefore, by opening the EGR valve 52 when it is expected that condensed water will be no longer generated, the EGR gas is recirculated with condensed water being prevented from entering the intake passage 30.

(6) When the coolant temperature TW is relatively high, it is assumed that the engine main body 20 has been sufficiently warmed up. In a state in which the engine main body 20 is sufficiently warmed up, it is assumed that the temperature of the inner wall surface of the exhaust passage 40 is relatively high. In the above-described embodiment, when the coolant temperature TW is higher than the coolant temperature threshold TWL, the controller 100 does not execute the recirculation prohibiting process, that is, prohibits the recirculation prohibiting process. Therefore, by opening the EGR valve 52 when it is expected that condensed water will be no longer generated, the EGR gas is recirculated with condensed water being prevented from entering the intake passage 30.

(7) In the above-described embodiment, the amount of water that can become condensed water increases as the intake air humidity IH increases. In the above-described embodiment, the controller 100 estimates a higher value of the generation amount AC per unit time of condensed water generated in the exhaust passage 40 for a higher value of the intake air humidity IH. The controller 100 thus estimates the generation amount AC of condensed water while taking the intake air humidity IH into consideration.

### Other Embodiments

The above-described embodiment may be modified as follows. The above-described embodiment and the following modifications can be combined as long as the combined modifications remain technically consistent with each other.

### Estimation Process

In the estimation process, the controller 100 may estimate the generation amount AC of condensed water without using the intake air amount GA. In this case, for example, the controller 100 may determine the value of the above-described coefficient k on the assumption that the intake air amount GA is constant.

Similarly, in the estimation process, the controller 100 may estimate the generation amount AC of condensed water without using the fuel injection amount FA. In this case, for example, the controller 100 may determine the value of the above-described coefficient k on the assumption that the fuel injection amount FA is constant.

In the estimation process, the controller 100 may calculate the amount of water in the intake air and the injected fuel using the saturation water vapor pressure at the outside air temperature detected by an outside air temperature sensor instead of the intake air humidity IH detected by the humidity sensor 67. In this case, the internal combustion engine 10 does not necessarily need to include the humidity sensor 67.

Similarly, in the estimation process, the controller 100 may estimate the generation amount AC of condensed water without using the intake air humidity IH. In this case, for example, the controller 100 may determine the value of the above-described coefficient k on the assumption that the proportion of water included in the intake air is constant.

In the estimation process, the controller 100 does necessarily need to use the difference obtained by subtracting the coolant temperature TW from the exhaust gas temperature TE as the degree of deviation between the exhaust gas temperature TE and the coolant temperature TW. The controller 100 may use, for example, a value obtained by dividing the exhaust gas temperature TE by the coolant temperature TW as the degree of deviation. Further, based on a map of the exhaust gas temperature TE and the coolant temperature TW, the degree of deviation may be divided into high, medium, and low regions. The degree of deviation may be obtained in any manner as long as the controller 100 estimates a higher value of the generation amount AC of condensed water for a higher value of the degree of deviation between the exhaust gas temperature TE and the coolant temperature TW. The coolant temperature TW is always lower than the exhaust gas temperature TE.

In the estimation process, the controller 100 does necessarily need to calculate the degree of deviation between the exhaust gas temperature TE and the coolant temperature TW. The controller 100 may estimate a lower value of the generation amount AC of condensed water for a higher value of the exhaust gas temperature TE, and may estimate a higher value of the generation amount AC of condensed water for a lower value of the coolant temperature TW. Even in this case, a lower value of the generation amount AC of condensed water is estimated for a higher value of the degree of deviation between the exhaust gas temperature TE and the coolant temperature TW.

In the estimation process, the controller 100 may estimate the generation amount AC of condensed water without using the degree of deviation between the exhaust gas temperature TE and the coolant temperature TW. For example, the controller 100 may execute the estimation process while assuming that coolant temperature TW has a constant value as long as the controller 100 estimates a lower value of the generation amount AC of condensed water for a higher value of the exhaust gas temperature TE.

The controller 100 may execute the estimation process regardless of whether the exhaust gas temperature TE is lower than or equal to the exhaust gas temperature threshold TEL. That is, step S12 may be omitted. Also, the controller 100 may execute the estimation process regardless of whether the coolant temperature TW is lower than or equal to the coolant temperature threshold TWL. That is, step S11 may be omitted.

### Recirculation Prohibiting Process

The controller 100 does not necessarily need to execute the recirculation prohibiting process. For example, after calculating the accumulation value IV of condensed water, the controller 100 may execute a control for reducing the condensed water instead of or in addition to the recirculation prohibiting process.

If the controller 100 does not execute the recirculation prohibiting process, the recirculation permitting process may be omitted. In addition, if the controller 100 does not execute the recirculation prohibiting process, the accumulation process may be omitted.

### Controller

The controller 100 may determine that the internal combustion engine 10 is started when the ignition switch is operated and the ON signal is received.

The configuration of the controller 100 is not limited to the one described in the above-described embodiment. The controller 100 may include one or more processors that perform various processes according to computer programs (software). The controller 100 may be circuitry including one or more dedicated hardware circuits such as application specific integrated circuits (ASICs) that execute at least part of various processes, or a combination thereof. The processor includes the CPU 101 and memory such as RAM, the ROM 103, and the like. The memory stores program code or instructions configured to cause the CPU 101 to execute processes. The memory, which is a computer-readable medium, includes any type of media that are accessible by general-purpose computers and dedicated computers.

### Another Embodiment

The number of the cylinders 21 may be less than or greater than four.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for an internal combustion engine, the internal combustion engine including an exhaust gas temperature sensor that detects, as an exhaust gas temperature, a temperature of exhaust gas flowing through an exhaust passage, wherein
the controller is configured to execute an estimation process that estimates a generation amount per unit time of condensed water generated in the exhaust passage, and
in the estimation process, the controller estimates a lower value of the generation amount for a higher value of the exhaust gas temperature that is detected by the exhaust gas temperature sensor.

2. The controller for the internal combustion engine according to claim 1, wherein
the internal combustion engine further includes a coolant temperature sensor that detects, as a coolant temperature, a temperature of a coolant flowing inside the internal combustion engine, and
in the estimation process, the controller estimates a higher value of the generation amount for a higher value of a degree of deviation between the exhaust gas temperature that is detected by the exhaust gas temperature sensor and the coolant temperature that is detected by the coolant temperature sensor.

3. The controller for the internal combustion engine according to claim 1, wherein, in the estimation process, the controller estimates a higher value of the generation amount for a higher value of an intake air amount of the internal combustion engine.

4. The controller for the internal combustion engine according to claim 1, wherein
the internal combustion engine includes:
an EGR passage configured to recirculate exhaust gas flowing through the exhaust passage to an intake passage; and
an EGR valve configured to regulate a flow rate of exhaust gas recirculated from the exhaust passage to the intake passage, and the controller is configured to execute
an accumulation process that accumulates the generation amount that is estimated by the estimation process so as to calculate an accumulation value of the condensed water that has been generated since the internal combustion engine was started, and
a recirculation prohibiting process that fully closes the EGR valve when the accumulation value that is calculated by the accumulation process is higher than a predetermined accumulation threshold.

5. The controller for the internal combustion engine according to claim 4, wherein the controller is configured to prohibit the recirculation prohibiting process when the exhaust gas temperature that is detected by the exhaust gas temperature sensor is higher than a predetermined exhaust gas temperature threshold.

6. A method for controlling an internal combustion engine, the internal combustion engine including an exhaust gas temperature sensor that detects, as an exhaust gas temperature, a temperature of exhaust gas flowing through an exhaust passage, wherein
the method comprises executing an estimation process that estimates a generation amount per unit time of condensed water generated in the exhaust passage, and
the estimation process includes estimating a lower value of the generation amount for a higher value of the exhaust gas temperature that is detected by the exhaust gas temperature sensor.
